(19) United States
(12) Patent Application Publication
(10) Pub. No.: US 2011/0050083 A1
(43) Pub. Date: Mar. 3, 2011

(54) PLASMA DISPLAY PANEL

(76) Inventors: Jun-Yong Park, Yongin-si (KR); Won-Hee Jeong, Yongin-si (KR); Su-Bin Song, Yongin-si (KR); Seung-Hyun Son, Yongin-si (KR); Joo-Sik Jung, Yongin-si (KR)

(21) Appl. No.: 12/846,715

(22) Filed: Jul. 29, 2010

(30) Foreign Application Priority Data
Aug. 28, 2009 (KR) 10-2009-0080700

(51) Int. Cl. H01J 63/04; H01J 17/49

(52) U.S. Cl. 313/484; 313/582

(57) ABSTRACT

A plasma display panel (PDP) includes a front substrate and a rear substrate that face each other; a pair of base portions disposed between the front substrate and the rear substrate and are concavely indented in directions away from each other; a pair of barrier walls disposed on the pair of base portions to define a discharge cell; a scan electrode and a sustain electrode that generate a mutual discharge in the discharge cell; an address electrode to cross the scan electrode and that generates an address discharge together with the scan electrode; a phosphor layer disposed in the discharge cell; and a discharge gas injected into the discharge cell.

### CROSS-REFERENCE TO RELATED APPLICATION

This application claims the benefit of Korean Patent Application No. 10-2009-0080700, filed Aug. 28, 2009, in the Korean Intellectual Property Office, the disclosure of which is incorporated herein by reference.

### BACKGROUND

1. Field

One or more embodiments relate to a plasma display panel (PDP).

2. Description of the Related Art

Plasma display panels (PDPs) are a type of flat display device that forms images of visible light produced from a phosphor material excited with ultraviolet (UV) rays generated by a plasma discharge.

In a general structure of the PDP, a front substrate, having discharge electrodes arranged thereon, and a rear substrate, having address electrodes arranged thereon, are attached to each other to face each other by interposing a plurality of barrier walls, which define a plurality of discharge cells, between the front and rear substrates. Then, a discharge gas is injected between the two substrates. A phosphor material coating the discharge cells, formed as a phosphor layer, is excited by applying a discharge voltage between the discharge electrodes resulting in images being formed of visible light generated as a result of the excitation.

In general, a large portion of the phosphor layer is attached to side surfaces of the barrier walls. However, the phosphor material may be a flowable paste such that the phosphor material sags and flows down from the side surfaces of the barrier walls resulting in the phosphor layer not being formed with a sufficiently large and uniform thickness. In addition, the visible light generated from the phosphor layer disposed on the side surfaces of the barrier walls is not emitted in an upward, display direction but rather in a direction orthogonal to the barrier walls. Consequently, visible light extraction efficiency therefrom is low. Furthermore, since bottom surfaces of the discharge cells on which the phosphor material is concentrated are relatively far from the front substrate where the discharge electrodes are arranged, a sufficient amount of UV light does not reach the phosphor layer and thus fails to effectively excite the phosphor layer. Since an address discharge occurs along a long discharge path corresponding to the height of a discharge cell, a high address driving voltage is required, and a sufficient voltage margin is not obtained.

### SUMMARY

One or more embodiments includes a highly efficient plasma display panel (PDP) that can be driven with low power and obtain high luminous brightness.

According to one or more embodiments, a PDP includes a front substrate and a rear substrate that face each other; a pair of base portions disposed between the front substrate and the rear substrate and are concavely indented in directions away from each other; barrier walls disposed on the pair of base portions to define a discharge cell; a scan electrode and a sustain electrode that generate a mutual discharge in the discharge cell; an address electrode to cross the scan electrode and that generates an address discharge together with the scan electrode; a phosphor layer disposed in the discharge cell; and a discharge gas injected into the discharge cell.

According to one or more embodiments, the base portions may include maximally indented summits at portions of the base portions which face a center of the discharge cell.

According to one or more embodiments, the concave indentations of the base portions may be concave curves having the summits.

According to one or more embodiments, the concave indentations of the base portions may be concave V shapes having the summits.

According to one or more embodiments, a distance between the base portions facing each other may be at a maximum at the centers of the base portions.

According to one or more embodiments, the scan electrode and the address electrode may cross in an area aligned with the base portions or cross in an area adjacent to the base portions.

According to one or more embodiments, the address electrode may include discharge portions and connecting portions, the discharge portions each having a relatively large line width with respect to the connecting portions, and the connecting portions each having a relatively small line width with respect to the discharge portions. According to one or more embodiments, the discharge portions may be disposed on the rear substrate under at least one of the base portions.

According to one or more embodiments, a non-discharge space may be disposed between adjacent barrier walls. According to one or more embodiments, a light absorbing layer may be disposed in the non-discharge space.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a plasma display panel (PDP) according to an embodiment;

FIG. 2 is a vertical cross-section taken along line II-II of FIG. 1;

FIG. 3 is an exploded perspective view of a part of the PDP of FIG. 1;

FIGS. 4 and 5 show a phosphor flow caused during baking and hardening of phosphor paste, wherein FIG. 4 is a plan view of a discharge cell of the PDP of FIG. 1 and FIG. 5 is a vertical cross-section taken along line V-V of FIG. 4;

FIG. 6 is a perspective view of a PDP according to another embodiment;

FIG. 7 is an exploded perspective view of a PDP according to another embodiment; and

FIG. 8 is an exploded perspective view of a PDP according to another embodiment.

### DETAILED DESCRIPTION

Reference will now be made in detail to the present embodiments, examples of which are illustrated in the accompanying drawings, wherein like reference numerals refer to the like elements throughout. The embodiments are described below in order to explain the present invention by referring to the figures.

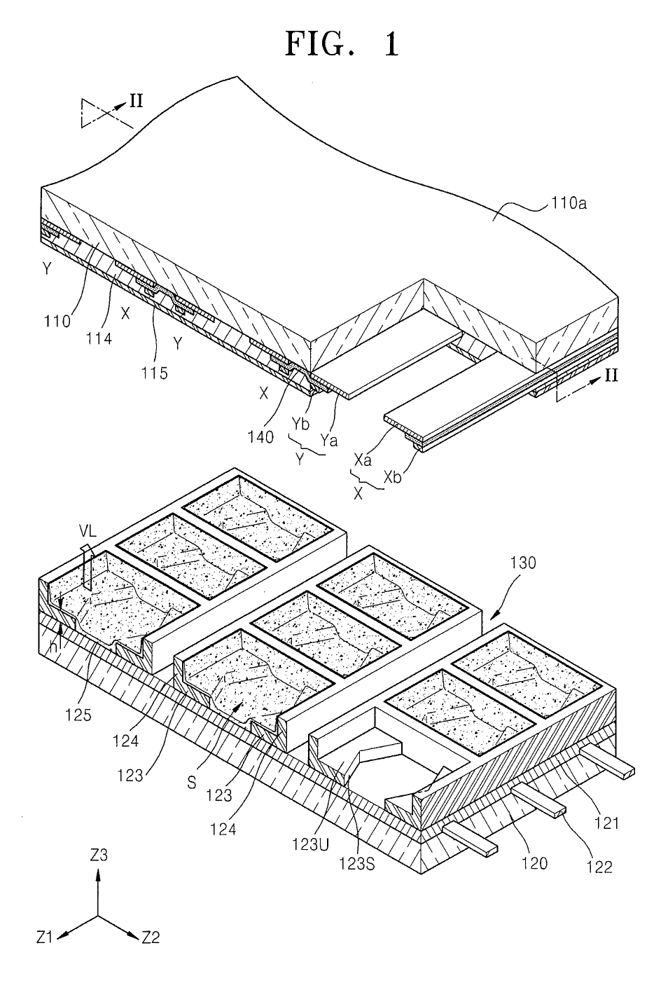

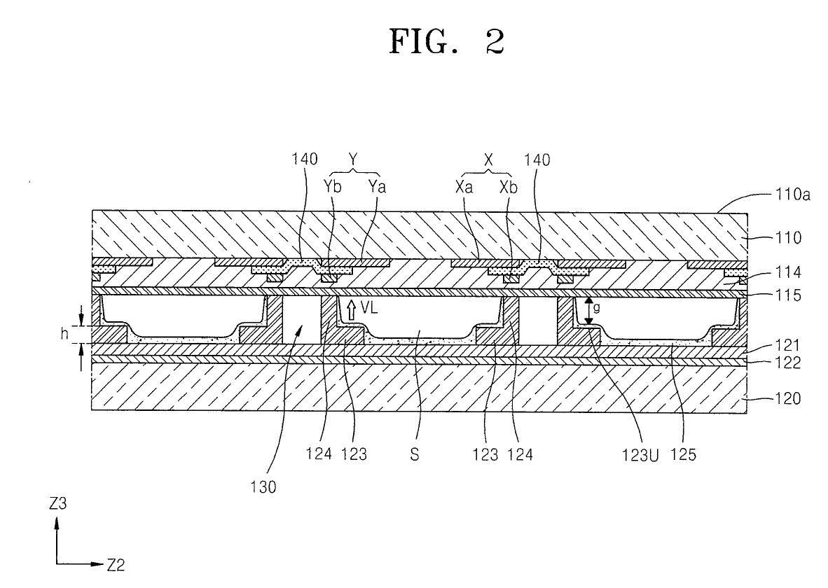

FIG. 1 is an exploded perspective view of a plasma display panel (PDP) according to an embodiment, and FIG. 2 is a vertical cross-section taken along line II-II of FIG. 1. Referring to FIGS. 1 and 2, the PDP includes a front substrate 110 and a rear substrate 120 that face and are apart from each other, and a plurality of discharge cells S are interposed between the front substrate 110 and the rear substrate 120.

A pair of base portions 123 is arranged in each discharge cell S on the rear substrate 120, and barrier walls 124, having smaller widths than the base portions 123, are arranged on the base portions 123. The barrier walls 124 and the base portions 123 may be integrally or separately formed. The barrier walls 124 include first barrier walls 124a that extend in a first direction (i.e., a Z2 direction as shown in FIG. 1) and second barrier walls 124b that extend in a second direction (i.e., a Z1 direction as shown in FIG. 1). However, aspects are not limited thereto such that the second barrier walls 124b need not be included. The first and second barrier walls 124a and 124b may have widths in the first and second directions, respectively, that are smaller than the widths of the base portions 123 in the first and second directions, respectively. The barrier walls 124 (i.e., first and second barrier walls 124a and 124b) define a discharge cell S that corresponds to or aligns with a scan electrode Y and a sustain electrode X, which generate a mutual display discharge, and each discharge cell S constitutes an independent light-emission unit. The base portions 123 form steps within the discharge cells S that extend from the first barrier walls 124a in the first direction (the Z2 direction) toward centers of the discharge cells S.

A non-discharge space 130 may be defined between barrier walls 124 which define different discharge cells S. As shown in FIGS. 1 and 2, the non-discharge spaces 130 may be disposed between first barrier walls 124a that define adjacent discharge cells S in the first direction (i.e., the Z1 direction), but aspects are not limited thereto such that the non-discharge spaces 130 may be disposed between the second barrier walls 124b that define adjacent discharge cells S in the second direction (i.e., the Z2 direction). The non-discharge space 130 provides a passage for impurity gas to flow so that a flow resistance in a process of exhausting impurity gas remaining in a panel may be reduced. A light absorption layer 140 may be disposed in, on, or to align with the non-discharge space 130. The light absorption layer 140 may be an external light absorption layer. The light absorption layer 140 may include a dark-colored pigment or a dark-colored material and improves a contrast characteristic and visibility of an image. However, the light absorption layer 140 is optional and need not be included in all aspects.

The sustain electrode X and the scan electrode Y, which generate a mutual display discharge, are arranged on the front substrate 110. The sustain electrodes X and the scan electrodes Y, are paired such that the sustain electrodes X and the scan electrodes Y generate a display discharge in discharge cells S corresponding to the pair. The sustain electrode X and the scan electrode Y include transparent electrodes Xa and Ya, respectively, which are formed of a phototransparent conductive material, and bus electrodes Xb and Yb, respectively, which electrically contact the transparent electrodes Xa and Ya and form power supply lines. As shown in FIGS. 1 and 2, the light absorption layer 140 is disposed on an internal surface of the front substrate 110 to align with the non-discharge space 130. The light absorption layer 140 may be further disposed on the transparent electrodes Xa and Ya of adjacent sustain electrodes X and the scan electrodes Y of adjacent discharge cells S, i.e., adjacent sustain electrodes X and the scan electrodes Y that are not paired as further described below. Further, the bus electrodes Xb and Yb may be disposed on the light absorption layer 140 so as to be electrically connected to the transparent electrodes Xa and Ya, respectively.

The sustain electrode X and the scan electrode Y are buried in a dielectric layer 114 disposed on the front substrate 110 so as not to be exposed to a discharge environment of the discharge cells S, thereby being protected from direct collision of charged particles participating in the discharge. The dielectric layer 114 may be protected by being covered with a protection layer 115 which is formed of, for example, an MgO thin layer.

Address electrodes 122 are arranged on the rear substrate 120. The address electrodes 122 perform address discharges with the scan electrodes Y. The scan electrodes Y and the address electrodes 122 may cross each other in areas of the discharge cells S corresponding to or aligning with the base portions 123 or areas of the discharge cells S adjacent to the base portions 123. A voltage applied between one the scan electrodes Y and one of the address electrode 122 forms a high electric field sufficient for discharge firing in the discharge cell S in which the scan electrode Y and the address electrode 122 cross via the dielectric layer 114 (or the protection layer 115) covering the scan electrodes Y and via the base portions 123 on the address electrodes 122. At this time, the dielectric layer 114 (or the protection layer 115) covering the scan electrodes Y and the base portions 123 on the address electrodes 122 form discharge surfaces that face each other, thereby generating the address discharge.

In a conventional structure, a discharge is generated between scan electrodes and address electrodes via a long discharge path between the front substrate and the rear substrate. In contrast, according to aspects, since the address discharge is performed via the base portions 123 protruding from the rear substrate 120 toward the scan electrodes Y by a height h, the address discharge path is reduced to the size of a discharge gap g (see FIG. 2) above the base portions 123 so that a driving efficiency may be improved compared to the conventional structure. Further, a dielectric layer 121 may be disposed on the rear substrate 120 to cover the address electrodes 122 such that the address electrodes 122 may be buried in the dielectric layer 121 disposed above the rear substrate 120. In such case, the base portions 123 may be disposed on a flat surface provided by the dielectric layer 121.

Phosphor layers 125 are disposed on the dielectric layers 121 between the base portions 123. The phosphor layers 125 generate visible rays of different colors, for example, red (R), green (G), and blue (B), by interacting with ultraviolet rays generated as a result of the display discharge. The position of the phosphor layers 125 is not limited to the position between the base portions 123 in the discharge cells S, and may extend to a neighboring position so as to cover parts of the base portions 123. For example, the phosphor layers 125 may continuously extend to upper surfaces 123U of the base portions 123, and further to the side surfaces of the barrier walls 124. Further, the phosphor layers 125 may be continuously extended up sides of the first and second barrier walls 124a and 124b.

Portions of the phosphor layers 125 disposed on the upper surfaces 123U of the base portions 123 are close to the scan electrode Y and the sustain electrode X and thus may be effectively excited. Also, the upper surfaces 123U of the base portions 123 are arranged close to the front substrate 110, which includes a display surface 110a, so as to face in a display direction (i.e., a Z3 direction of FIG. 1). Thus, visible rays VL of FIG. 2 emitted from the phosphor layers 125 on the base portions 123 may comparatively more quickly exit the display surface 110a, and an extraction efficiency of the visible ray VL may be improved.

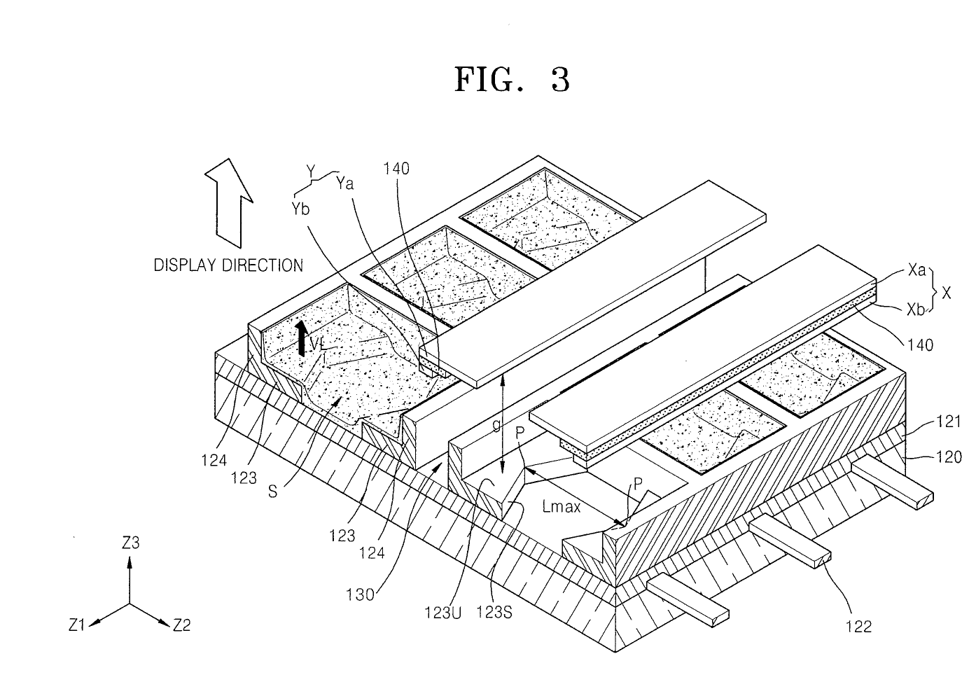

FIG. 3 is an exploded perspective view of a part of the PDP of FIG. 1. Referring to FIG. 3, side surfaces 123S of the base portions 123 are indented so as to be concave with respect to the center of the discharge cell S. In detail, the side surfaces 123S of a pair of base portions 123 have concave shapes that are indented in directions farther from the respective other parts of the base portions 123 (directions ±Z2). The side surfaces 123S of the base portions 123 have V shapes in which summits P are disposed at the centers of the base portions 123 in the Z1 direction, which face the center of each discharge cell S. A distance between the side surfaces 123S of the base portions 123 facing each other is a maximum Lmax at the summits P among the entire side surfaces 123S of the base portions 123. Accordingly, a sufficient distance of Lmax that enables a display discharge to occur without interference of the base portions 123 is secured, whereby charge loss, in which charged particles participating in the display discharge are lost due to collision with the base portions 123, may be reduced.

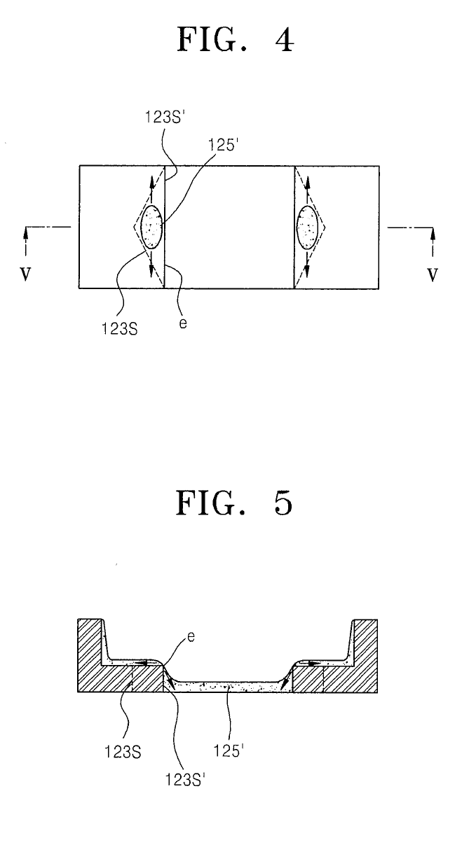

FIGS. 4 and 5 show a phosphor flow caused during baking and hardening of phosphor paste 125′. FIG. 4 is a plan view of a discharge cell S, and FIG. 5 is a vertical cross-section taken along line V-V of FIG. 4. Referring to FIG. 4, when the base portions 123 have flat side surfaces 123S′, the phosphor paste 125′ coated on edges e of the base portions 123 are subject to left and right surface tensions. Referring to FIG. 5, the phosphor paste 125′ coated on the edges e of the base portions 123 are also subject to surface tension in upward and downward sides where a relatively large amount of phosphor paste 125′ has been coated. Consequently, a small amount or none of the phosphor paste 125′ remains on the edges e of the base portions 123, so that the luminous brightness degrades. As indicated by dotted lines of FIG. 4, when the base portions 123 have concave side surfaces 123S, the side surfaces 123S of the base portions 123 are relatively farther away from a center of the discharge cells S compared to the flat side surfaces 123S′ (see FIG. 5). Thus, phosphor paste 125′ may more thickly accumulate in the center of the discharge cell S when the base portions 123 have the concave side surfaces 123S than in the case where the base portions 123 have the flat side surfaces 123S′ by reducing phosphor paste detachment caused due to surface tension.

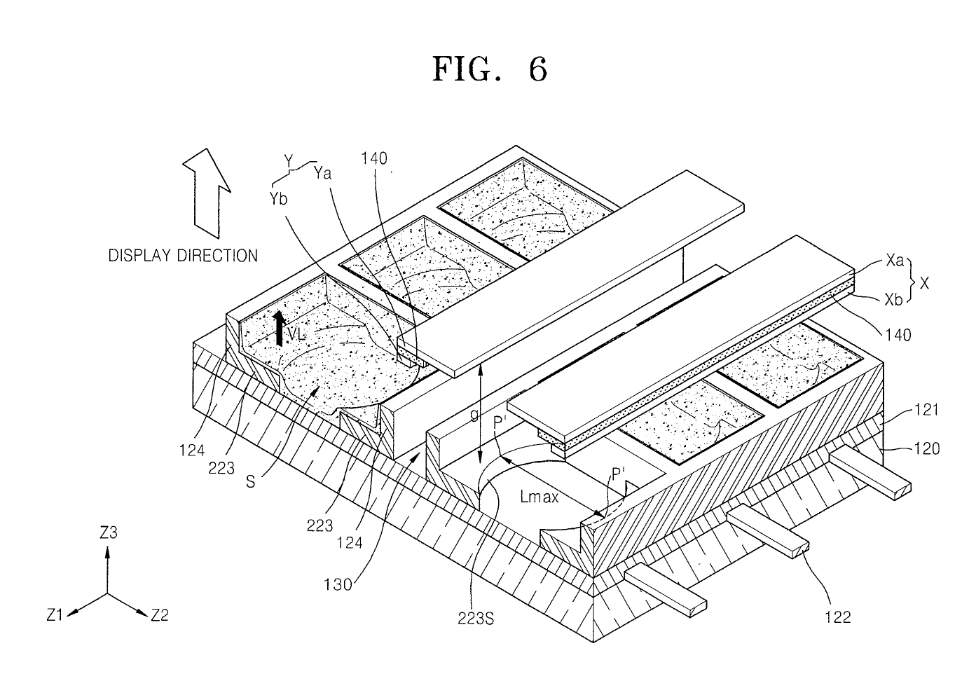

The shape of the base portions 123 is not limited to the above example, and the base portions 123 may be modified into other various shapes as long as they are indented concavely. FIG. 6 illustrates a PDP including base portions 223 according to another embodiment. Side surfaces 223S of the base portions 223 may be formed along concave curves that have summits P′ at the centers, in the Z1 direction, of the base portions 223, which face the center of each discharge cell S. Accordingly, the side surfaces 223S of the base portions 223 may be formed along concave curves having an arbitrary curvature, including semicircular or oval lines. The barrier walls 124 and the base portions 223 may be integrally or separately formed.

A discharge gas (not shown) is injected into the discharge cells S. The discharge gas may be a multi-element gas in which xenon (Xe), krypton (Kr), helium (He), neon (Ne), and the like, capable of providing UV light through discharge excitation, are mixed at a determined volumetric ratio.

Table 1 shows the result of an experiment for showing effects achieved by forming a base portion having a concave side surface. A base portion according to an embodiment had a concave V shape, while a base portion according to a comparative example had a flat plane, i.e., the side surfaces of the base portions had a concave V shape and flat shape, respectively. The Experimental Example had the same structure as the Comparative Example except for the shape of a base portion. In the experiment, a discharge gas of Xe 15%-He 61% was used, and the driving efficiency represents brightness per consumed unit power. The driving efficiency was measured when 30% of all effective cells were lit.

TABLE 1

| | | Experimental | Comparative |
|---|---|---|---|
| Remarks | | Example | Example |
| Discharge voltage | sustain voltage (V) | 228 | 237 |
| | address voltage (V) | 194 | 197 |
| Driving efficiency | driving efficiency | 1.59 | 1.5 |
| (30% Load) | (cd/W) | | |
| | luminous brightness | 650 | 590 |
| | (cd) | | |
| | Consumed power | 409 | 393 |
| | (W) | | |
| Discharge delay | Delay time (nsec) | 946 | 1014 |

According to the results of the experiment, the sustain voltage and the address voltage in the Experimental Example were smaller than those in the Comparative Example, and the driving efficiency in the Experimental Example was higher than that in the Comparative Example. In addition, a delay time between the moment when a discharge firing signal was applied and the moment when actual discharge occurred was reduced in the Experimental Example with respect to the Comparative Example.

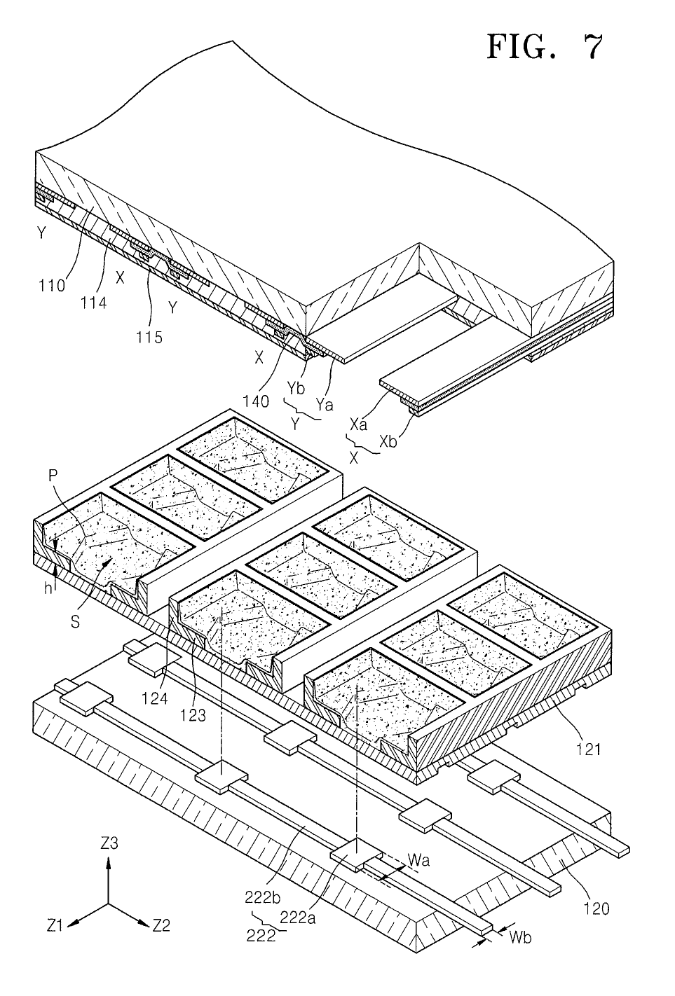

FIG. 7 is an exploded perspective view of a PDP according to another embodiment. As described above with reference to FIGS. 1 through 5, the scan electrodes Y and address electrodes 222 generate an address discharge through the base portions 123 each having the height h, thereby reducing a discharge gap and accelerating the address discharge.

In the present embodiment, the line width of each of the address electrodes 222 varies along the length direction thereof, i.e, the Z2 direction. In detail, each of the address electrodes 222 includes discharge portions 222a, having large line widths Wa, and connecting portions 222b, having small line widths Wb, between the discharge portions 222a. The discharge portions 222a are disposed directly under the base portions 123 and are arranged to face the scan electrodes Y. Since the discharge portions 222a are formed to have the large line widths Wa, a high electric field may be formed through the base portions 123, and the address discharge by the discharge portions 222a and the scan electrodes Y may be accelerated. The connecting portions 222b connect the discharge portions 222a together so as to form a single electrode unit and transmit a driving signal to each of the discharge portions 222a.

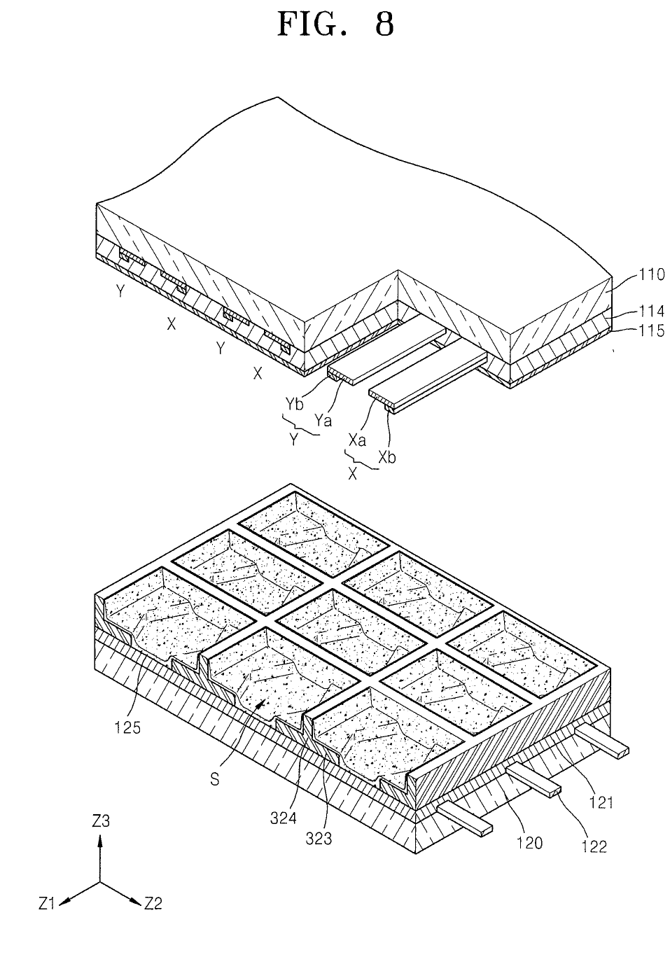

FIG. 8 is an exploded perspective view of a PDP according to another embodiment. In the present embodiment, a non-discharge space is not disposed between adjacent discharge cells S. In detail, a barrier wall 324 is disposed at an almost-center position of a base portion 323, and the barrier wall 324 defines two adjacent discharge cells S. The barrier walls 324 and the base portions 323 may be integrally or separately formed.

As described above, in a PDP according to the one or more of the above embodiments, phosphor layers are disposed on planes that are close to discharge electrodes that generate a mutual display discharge and to a display plane, so that phosphor may be more effectively excited and the visible light extraction efficiency may increase. In particular, the shape of a base portion is suitably designed by analyzing the flow of flowable phosphor paste so that the paste is securely attached, thereby increasing overall display light emission. The shape of a base portion is also designed in consideration of a discharge path, thereby decreasing charge loss that occurs when charged particles participating in discharge are uselessly lost due to collisions with the base portions or other interferences. Due to shortening of an address discharge path, low-voltage addressing is possible, and a sufficient voltage margin may be secured.

Although a few embodiments have been shown and described, it would be appreciated by those skilled in the art that changes may be made in this embodiment without departing from the principles and spirit of the invention, the scope of which is defined in the claims and their equivalents.

What is claimed is:

1. A plasma display panel (PDP) comprising:
a front substrate and a rear substrate that face each other;
a pair of base portions disposed between the front substrate and the rear substrate and are concavely indented in directions away from each other;
barrier walls disposed on the pair of base portions to define a discharge cell;
a scan electrode and a sustain electrode that generate a mutual discharge in the discharge cell;
an address electrode to cross the scan electrode and that generates an address discharge together with the scan electrode;
a phosphor layer disposed in the discharge cell; and
a discharge gas injected into the discharge cell.

2. The PDP of claim 1, wherein the base portions comprise maximally indented summits at portions of the base portions which face a center of the discharge cell.

3. The PDP of claim 2, wherein the concave indentations of the base portions are concave curves having the summits.

4. The PDP of claim 2, wherein the concave indentations of the base portions are concave V shapes having the summits.

5. The PDP of claim 1, wherein a distance between the base portions facing each other is at a maximum at centers of the base portions.

6. The PDP of claim 1, wherein the scan electrode and the address electrode cross in an area aligned with the base portions or in an area aligned adjacent to the base portions.

7. The PDP of claim 1, wherein:
the address electrode includes discharge portions and connecting portions, the discharge portions each having a relatively large line width with respect to the connecting portions, and the connecting portions each having a relatively small line width with respect to the discharge portions; and
the discharge portions are disposed on the rear substrate under at least one of the base portions.

8. The PDP of claim 1, wherein a non-discharge space is disposed between adjacent barrier walls.

9. The PDP of claim 8, wherein a light absorbing layer is disposed in the non-discharge space.

10. A plasma display panel (PDP) comprising:
a front substrate and a rear substrate that face each other;
barrier walls disposed between the front and rear substrates to define discharge cells therebetween;
a pair of base portions disposed within each discharge cell, each base portion having a concave indentation disposed in a direction away from a center of the discharge cell;
scan electrodes and sustain electrodes disposed on the front substrate;
address electrodes disposed on the rear substrate, the address electrodes crossing the scan electrodes such that one of the base portions is disposed therebetween.

11. The PDP of claim 10, wherein each of the address electrodes comprises:
discharge portions and connecting portions, the discharge portions each having a relatively large line width with respect to the connecting portions, and the connecting portions each having a relatively small line width with respect to the discharge portions.

12. The PDP of claim 11, wherein the discharge portions are disposed on the rear substrate where the address electrodes cross the scan electrodes.

13. The PDP of claim 10, wherein the barrier walls comprise:
first barrier walls disposed parallel to the scan and sustain electrodes; and
second barrier walls disposed parallel to the address electrodes.

14. The PDP of claim 13, further comprising:
non-discharge spaces disposed between first barrier walls of adjacent discharge cells.

15. The PDP of claim 14, further comprising:
light absorbing layers disposed on the front substrate in the non-discharge spaces.

16. The PDP of claim 10, wherein the concave indentations of the base portions are V-shaped.

17. The PDP of claim 10, wherein the concave indentations of the base portions are curved.

18. The PDP of claim 10, wherein the barrier walls and the base portions are integrally formed.

19. The PDP of claim 10, wherein the base portions are disposed on opposite sides of each discharge cell, and the concave indentations of the base portions are at a maximum at central portions of the base portions.

20. The PDP of claim 19, wherein the opposite sides are sides of the discharge cell that cross the address electrodes.
